(19) United States
(12) Patent Application Publication
(10) Pub. No.: US 2010/0015295 A1
(43) Pub. Date: Jan. 21, 2010

(54) METHOD OF PREVENTING STALING IN BAKED GOODS

(76) Inventors: Olav M. Haas, Paw Paw, MI (US); Glenn Quinlan, Battle Creek, MI (US); Albert Peter Karls, JR., Marshall, MI (US); Brianna Kay, Durham, NC (US); Pamela J. Stanyon, Delton, MI (US); Jeffrey M. Paxhia, Battle Creek, MI (US)

Correspondence Address: DICKINSON WRIGHT PLLC, 38525 WOODWARD AVENUE, SUITE 2000, BLOOMFIELD HILLS, MI, 48304-2970, US

(21) Appl. No.: 12/505,661

(22) Filed: Jul. 20, 2009

Related U.S. Application Data
(60) Provisional application No. 61/082,261, filed on Jul. 21, 2008.

(51) Int. Cl. A21D 15/08; A21D 13/00; A23G 1/54

(52) U.S. Cl. 426/94; 426/303

(57) ABSTRACT

Disclosed is method for enhancing the shelf life of a baked good. Shelf life is defined as maintaining the % moisture, water activity, and organoleptically perceived tenderness and moistness of the baked good while preventing drying out and hardening of the baked good during storage at room temperature. In the disclosed method the baked good, preferably as it comes out of the baking apparatus, is topically coated with a primary lipid-based coating oil on all surfaces. The primary lipid-based coating oil, which is largely a solid at room temperature, is applied at a temperature above its melting point. The primary lipid-based coating oil preferably has a solid fat content at 20° C. of at least 68%. The baked good is then allowed to cool permitting the primary lipid-based coating oil to penetrate the baked good and to solidify. The coated baked good is then coated with a secondary lipid-based coating comprising a compound coating or a chocolate coating. The baked good treated as described has a shelf life of at least 4 months at room temperature, more preferably at least 6 months and most preferably at least 8 months.

### RELATED APPLICATIONS

This application claims the benefit of U.S. Provisional Application No. 61/082,261 filed Jul. 21, 2008.

### STATEMENT REGARDING FEDERALLY SPONSORED RESEARCH

NONE

### TECHNICAL FIELD

This invention relates generally to baked goods and, more particularly, to methods for preventing staling in baked goods wherein the baked good has reduced drying and enhanced tenderness over an extended storage time at room temperature.

### BACKGROUND OF THE INVENTION

Consumers enjoy a wide variety of baked goods such as breads, cakes, and cookies. In particular consumers enjoy snack sized cakes. Often these snack sized cakes are a form of sponge cake wherein the cakes are leavened through the incorporation of whipped eggs and other leavening agents. Typically, these cakes are stored at room temperature prior to purchase by consumers and this shortens their shelf life. In the past these cakes have tended to dry out and become harder within 4 to 6 weeks after production thus ending their effective shelf life. One way to extend shelf life in the past has been to completely coat the cakes with a compound coating, with a frosting or with chocolate. While this does extend the shelf life a bit to about 2 months it would be beneficial if the shelf life could be extended to 4 months or beyond. Thus, it would be highly desirable to create a process that would allow for a baked good that could be stored at room temperature for extended periods of time without drying out or hardening leading to a shelf life of 4 months or more.

### SUMMARY OF THE INVENTION

In general terms, this invention provides a method for enhancing the shelf life of a baked good. Shelf life is defined as the ability to maintain the moisture content, water activity and organoleptically perceived moistness and tenderness and to reduce drying and organoleptically perceived hardness of the baked good during storage at room temperature. As is known in the art, trained organoleptic panelists are used to evaluate criteria such as perceived tenderness and moistness of baked goods. The method comprises preparing a baked good; topically applying to all surfaces of the baked good a primary lipid-based coating oil at a temperature above the melting point of the primary lipid-based coating oil, wherein the primary lipid-based coating oil has a solid fat content at 20° C. of from 68 to 87%; and then allowing the coated baked good to cool so that the primary lipid-based coating oil can penetrate the baked good and solidify. The baked good is then further fully enrobed with a secondary lipid-based coating that is either a compound coating or a chocolate.

These and other features and advantages of this invention will become more apparent to those skilled in the art from the detailed description of a preferred embodiment.

### DETAILED DESCRIPTION OF A PREFERRED EMBODIMENT

The present invention is directed toward a method for preparing a baked good that has an enhanced shelf life upon storage at room temperature, generally 70 to 80° F. The present invention is applicable to a variety of baked goods including cakes, sponge cakes, cookie cakes, muffins and other baked goods. The present invention comprises coating the baked goods first with a primary lipid-based coating oil and then with a secondary lipid-based coating to maintain the freshness of the baked good over an extended period of time of storage at room temperature. The method does not require any change to the formulation of the baked good, but does add steps to the process after the baked good is prepared.

The present invention comprises use of a primary lipid-based coating oil and a secondary lipid-based coating to provide enhanced shelf life of the baked good. The preferred primary lipid-based coating oil is preferably an oil that is largely a solid at room temperature and not a liquid. In the present specification and claims the terms oil and fat are used interchangeably unless noted otherwise. The primary lipid-based coating oil can either comprise a single oil or a blend of oils provided it meets the characteristics given in Table I below. In the present specification and claims the term oil includes both a single oil and a blend of oils. Preferred oils include coconut oil, palm oil, palm kernel oil, hydrogenated forms of these oils, interesterified forms of these oils, and blends of these oils with each other or with other vegetable oils that have been hydrogenated, or interesterified, or not such as cottonseed oil, soybean oil, canola oil, and sunflower oil. The oils can either be fully or partially hydrogenated. Preferably the primary lipid-based coating oil also includes 10 to 20 ppm of citric acid.

TABLE 1

| | Preferred | AOCS test |
|---|---|---|
| Characteristic | value range | method |
| Mettler Dropping Point | 35 to 45° C. | Cc 18-80 |
| FFA (% as oleic) | 0.1% or less | Ca 5a-4 |
| Peroxide value | 1.0 or less | Cd 8-53 |
| Iodine value | 6.0 or less | Cd 1-25 |
| Solid Fat Content at 20° C. | 68 to 87% | Cd 16b-93 |
| Solid Fat Content at 35° C. | 3 to 12% | Cd 16b-93 |
| Solid Fat Content at 40° C. | 5% or less | Cd 16b-93 |
| Saturated fatty acid level | 95% or more | Ce 1f-96 |
| Trans fatty acid level | 2.5% or less | Ce 1f-96 (100 m column) |

The method comprises preparing the baked good per its usual procedure and baking it as appropriate. The primary lipid-based coating oil is heated to a temperature above its melting temperature and held there in liquid form. The liquefied primary lipid-based coating oil is then topically applied to all surfaces of the baked good after it exits from the baking oven. The topical application can occur by processes well known to those of ordinary skill in the art and include spraying, dipping, brushing, and via waterfall. Preferably the primary lipid-based coating oil is applied to a level of from 2% to 8% by weight based on the total weight of the baked good, more preferably to a level of from 4% to 7% by weight. The primary lipid-based coating oil fully coats the baked good and penetrates the baked good. The coated baked good is then allowed to cool for a period of time, generally from 15 to 20 minutes, to allow the primary lipid-based coating oil to penetrate the baked good and to solidify as it cools.

The baked good is then fully enrobed with the secondary lipid-based coating. The secondary lipid-based coating must fully enclose the coated baked good for the process to be effective in enhancing shelf life. If there are holes or gaps in the secondary lipid-based coating the process is not effective. The secondary lipid-based coating is either a compound coating or a chocolate coating and can include white chocolate coatings. To be defined as a chocolate coating or white chocolate the coating must include cocoa butter at specific levels and other cocoa components as is known to those of ordinary skill in the art. Thus, further descriptions of chocolate and white chocolate will not be provided. Compound coatings, as is well known in the art, comprise at least a lipid component, generally a hard fat or blend of fats, and at least a sweetener component. Compound coatings can also include protein, dairy-derived components, yogurt components, cocoa, flavors, and colors. The sweeteners can include nutritive carbohydrates and non-nutritive sweeteners. The sweeteners can be mono-saccharides, di-saccharides, poly-saccharides, and mixtures thereof. Some examples include: sucrose, maltose, trehalose, lactose, dextrose, corn syrups, high fructose corn syrups, dextrin, xylose, ribose, glucose, fructose, mannose, galactose, sucromalt, invert sugar, maltodextrins, honey, and mixtures thereof. Artificial sweeteners can also be used as known in the art. Flavors are well known in the art and include vanilla, chocolate, strawberry and other fruit flavors.

In Table 2 below the specific characteristics of several suitable oils useful for the lipid component used for creating the secondary lipid-based coating are provided for when the secondary lipid-based coating is a compound coating. Other source oils and oil blends can be used to create compound coatings provided they meet the criteria shown in Table 1 above for the primary lipid-based coating oil. Preferably the secondary lipid-based coating also includes from 10 to 20 ppm citric acid.

TABLE 2

| Characteristic | Oil 1 | Oil 2 | Oil 3 | Oil 4 |
|---|---|---|---|---|
| Source oil(s) | partially hydrogenated | partially hydrogenated | interesterified and | partially hydrogenated |
| | palm kernel oil | palm kernel oil | partially hydrogenated | palm kernel oil, palm |
| | | and cottonseed oil | palm kernel oil, palm | oil, and coconut oil |
| | | | oil, and coconut oil | |
| Mettler Dropping | 35 to 39 | 37.8 to 41.1 | 37.8 to 41.1 | 40.5 to 43.9 |
| Point, ° C. | | | | |
| FFA (% as oleic) | 0.1 max | 0.05 max | 0.05 max | 0.05 max |
| Peroxide value | ND | 1.0 max | 1.0 max | 1.0 max |
| Iodine value | 4.0 max | 4.0 max | 4.0 max | 6.0 max |
| Solid fat content at | 80 to 87% | 76 to 82% | 68 to 74% | 76 to 82% |
| 20° C. | | | | |
| Solid fat content at | 3 to 9% | 4 to 8% | 4 to 8% | 8 to 12% |
| 35° C. | | | | |
| Solid fat content at | ND | 3% max | 2% max | 5% max |
| 40° C. | | | | |
| Saturated fatty acid | ND | 96.6% | 98.5% | 96.5% |
| level | | | | |
| Trans fatty acid | ND | 1.7% | 1.5% | 2.5% max |
| level | | | | |
| Citric acid level | 10 to 20 ppm | 10 to 20 ppm | 10 to 20 ppm | 10 to 20 ppm |

The secondary lipid-based coating must fully enrobe the coated baked good for the process to be effective in enhancing shelf life. The secondary lipid-based coating can be applied by any of the methods known in the art as described above for the primary lipid-based coating oil. Baked goods treated with only the primary or only the secondary lipid-based coating did not have an enhanced shelf life compared to uncoated baked goods. The present invention requires use of both the primary and the secondary lipid-based coatings. Preferably the secondary lipid-based coating, whether it is a compound coating or a chocolate, is applied at a level of from 35% to 45% by weight based on the total weight of the baked good coated with the primary lipid-based coating oil, more preferably from 36% to 42% by weight. Baked goods treated in accordance with the present invention have a longer shelf life as measured by a maintenance of % moisture, maintenance of water activity, and maintenance of organoleptically perceived moistness and tenderness over storage. The present invention provides a reduction in drying out and maintenance of tenderness of the baked good over extended storage at room temperature. When the present invention is followed the shelf life can be extended to at least 4 months, more preferably to at least 6 months and most preferably to at least 8 months or more. This is far beyond the shelf life currently achievable with compound coatings or chocolate coatings alone. The process of the present invention can readily be applied to methods for forming most baked goods. It is especially useful for snacking cakes. The process is illustrated below in the several examples.

A cake can be prepared using one of the cake batter formulations described in Table 3 below. In a first step the shortening and first granulated sugar are combined in a mixer and mixed for 2 minutes at high speed. Next the vanilla flavor, cocoa, emulsifier, modified starch, corn starch, whey powder, salt, bicarbonate, monocalcium phosphate, cake flour, and corn syrup are added to the mixer and mixed for 3 minutes on low speed with scraping after the first minute of mixing. Then the High Fructose Corn Syrup 42% is added to the mixer with scraping. Finally, the remaining ingredients are added to the mixer as a premix and the mixing is continued for 7 minutes at low speed. The cake dough is then optionally run through an aerating mixer. Finally, a wire cut machine is used to form cakes of from 8 to 10 grams each. The cakes are baked for approximately 9 minutes to a final moisture content of approximately 10.5% and a water activity Aw of about 0.62. The baked cakes are removed from the oven and the melted primary lipid-based coating oil is topically applied to all surfaces of the cakes using an oil spraying machine. The primary lipid-based coating oil is applied at a level of from 2 to 8% by weight based on the total weight of the cake. The oil coated cakes are then allowed to cool for a period of time of from 15 to 20 minutes. After the cooling period the primary lipid-based coating oil has penetrated the cake and solidified again.

TABLE 3

| | Chocolate cake | Yellow cake |
|---|---|---|
| Component | mix, wgt % | mix, wgt % |
| Shortening | 12.00 to 16.00 | 14.00 to 18.00 |
| Granulated sugar | 16.00 to 20.00 | 16.00 to 20.00 |
| Vanilla Flavor | 0.40 to 0.60 | 0.40 to 0.60 |
| Cocoa powder | 6.00 to 8.00 | 0.00 |
| Emulsifier | 1.50 to 2.50 | 1.50 to 2.50 |
| Modified starch | 0.40 to 0.80 | 0.40 to 0.80 |
| Corn starch | 0.50 to 0.70 | 0.50 to 0.70 |
| Whey powder | 1.00 to 1.50 | 1.00 to 1.50 |
| Salt | 0.50 to 0.80 | 0.50 to 0.80 |
| Bicarbonate | 0.15 to 0.25 | 0.15 to 0.25 |
| Monocalcium phosphate | 0.00 to 0.01 | 0.00 to 0.01 |
| Cake flour | 20.00 to 28.00 | 25.00 to 35.00 |
| Corn syrup 62 DE | 4.50 to 6.50 | 4.50 to 6.50 |
| High fructose corn syrup | 6.00 to 9.00 | 6.00 to 9.00 |
| 42% | | |
| Water | 12.00 to 16.00 | 12.00 to 16.00 |
| Yellow color | 0.00 | 0.00 to 0.02 |
| Whole egg powder | 3.00 to 4.00 | 3.00 to 4.00 |
| Xanthan gum | 0.01 to 0.02 | 0.01 to 0.02 |
| Methocel | 0.06 to 0.08 | 0.06 to 0.08 |

The oil coated cakes are then further coated with the secondary lipid-based coating comprising a compound coating or a chocolate coating. The secondary lipid-based coating is applied to all of the surfaces of the cake through methods known in the art including by waterfall, spraying, dipping, bath, and other methods know to those of skill in the art. Examples of two secondary lipid-based coatings comprising compound coatings can be found in Table 4 below. One of ordinary skill in the art can easily develop other compound coatings that could be used in the present invention. The only consideration in selection of the compound coating is that the oil used in the compound coating be compatible with the criteria established above in Tables 1 and 2. If a chocolate coating is used the industry standards for meeting the definitions of chocolate must be used as are known in the art. The secondary lipid-based coating is preferably applied at a level of from 35% to 45% by weight based on the total weight of the primary lipid-based oil coated cake, more preferably at a level of from 36% to 42% by weight. A baked good having the primary and secondary coatings has a shelf life of at least 4 months at room temperature, more preferably at least 6 months and most preferably at least 8 months.

TABLE 4

| | Compound | Compound |
|---|---|---|
| Component | coating 1 | coating 2 |
| Fine granulated sugar | 57.60 | 55.74 |
| Whey powder | 4.17 | 0.00 |
| Light Dutch cocoa powder | 7.61 | 0.00 |
| Grinding starch | 0.00 | 1.72 |
| Natural cocoa powder | 0.00 | 8.98 |
| Flour salt | 0.06 | 0.10 |
| Vanillin | 0.05 | 0.04 |
| Oil 3, Table 2 | 29.60 | 0.00 |
| Oil 2, Table 2 | 0.00 | 32.92 |
| Lecithin | 0.27 | 0.50 |
| Polysorbate 60 | 0.32 | 0.00 |
| Sorbitan monostearate | 0.32 | 0.00 |

Generally, the water activity of the uncoated baked good is from 0.62 to 0.68. Adding the primary and secondary coatings of the present invention lowers the water activity lower than that of the uncoated baked good generally from less than 0.6 up to 0.66. Using the present invention permits the coated baked good to maintain its % moisture and water activity level over extended shelf storage. In addition, the organoleptically perceived moistness and tenderness of the baked good is maintained over extended shelf storage compared to uncoated baked goods or to baked goods having only a single coating.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

We claim:

1. A method for enhancing the shelf life of a baked good comprising the following steps:
a) providing a baked good;
b) topically applying to all surfaces of the baked good a primary lipid-based coating oil that is at a temperature above the melting point of the primary lipid-based coating oil, the primary lipid-based coating oil having a solid fat content at 20° C. of from 68 to 87%;
c) allowing the coated baked good to cool and the primary lipid-based coating oil to solidify; and then
d) applying a secondary lipid-based coating comprising one of a compound coating or a chocolate to all surfaces of the coated baked good.

2. The method as recited in claim 1 wherein step a) comprises providing a bread, a cake, a sponge cake, a cookie, a muffin, or a cup cake.

3. The method as recited in claim 1 wherein step b) comprises applying a primary lipid-based coating oil having a Mettler Dropping Point of from 35 to 45° Celsius.

4. The method as recited in claim 1 wherein step b) comprises applying a primary lipid-based coating oil having a solid fat content at 35° C. of from 3% to 12%.

5. The method as recited in claim 1 wherein step b) comprises applying a primary lipid-based coating oil having a solid fat content at 40° C. of less than or equal to 5%.

6. The method as recited in claim 1 wherein step b) comprises applying a primary lipid-based coating oil having a saturated fat content of greater than or equal to 95%.

7. The method as recited in claim 1 wherein step b) comprises applying a primary lipid-based coating oil having a trans fatty acid content of less than or equal to 2.5%.

8. The method as recited in claim 1 wherein step b) comprises applying a primary lipid-based coating oil comprising a coconut oil, a palm oil, a palm kernel oil, a hydrogenated coconut oil, a hydrogenated palm oil, a hydrogenated palm kernel oil, an interesterified coconut oil, an interesterified palm oil, an interesterified palm kernel oil, a soybean oil, a hydrogenated soybean oil, an interesterified soybean oil, a cottonseed oil, a hydrogenated cottonseed oil, an interesterified cottonseed oil, a canola oil, a hydrogenated canola oil, an interesterified canola oil, a sunflower oil, a hydrogenated sunflower oil, an interesterified sunflower oil, or blends thereof.

9. The method as recited in claim 1 wherein step b) further comprises applying a primary lipid-based coating oil comprising 10 to 20 ppm citric acid.

10. The method as recited in claim 1 wherein step b) comprises applying the primary lipid-based coating oil at a level of from 2% to 8% by weight based on the total weight of the baked good.

11. The method as recited in claim 1 wherein step c) comprises allowing the coated baked good to cool for a period of time of from 15 to 20 minutes.

12. The method as recited in claim 1 wherein step d) comprises applying the secondary lipid-based coating at a level of from 35% to 45% by weight based on the total weight of the coated baked good from step c).

13. The method as recited in claim 1 wherein step d) comprises applying a compound coating wherein the lipid component of the compound coating has a solid fat content at 20° C. of from 68% to 87%.

14. The method as recited in claim 1 wherein step d) comprises applying a compound coating wherein the lipid component of the compound coating has a solid fat content at 35° C. of from 3% to 12%.

15. The method as recited in claim 1 wherein step d) comprises applying a compound coating wherein the lipid component of the compound coating has a solid fat content at 40° C. of less than or equal to 5%.

16. The method as recited in claim 1 wherein step d) comprises applying a compound coating wherein the lipid component of the compound coating has a Mettler Dropping Point of from 35 to 45° C.

17. The method as recited in claim 1 wherein step d) comprises applying a compound coating wherein the lipid component of the compound coating has a saturated fat content of greater than or equal to 95%.

18. The method as recited in claim 1 wherein step d) comprises applying a compound coating wherein the lipid component of the compound coating has a trans fatty acid content of less than or equal to 2.5%.

19. The method as recited in claim 1 wherein step d) comprises applying a compound coating wherein the lipid component of the compound coating comprises a coconut oil, a palm oil, a palm kernel oil, a hydrogenated coconut oil, a hydrogenated palm oil, a hydrogenated palm kernel oil, an interesterified coconut oil, an interesterified palm oil, an interesterified palm kernel oil, a soybean oil, a hydrogenated soybean oil, an interesterified soybean oil, a cottonseed oil, a hydrogenated cottonseed oil, an interesterified cottonseed oil, a canola oil, a hydrogenated canola oil, an interesterified canola oil, a sunflower oil, a hydrogenated sunflower oil, an interesterified sunflower oil, or blends thereof

20. The method as recited in claim 1 wherein step d) comprises applying a compound coating wherein the compound coating further includes 10 to 20 ppm of citric acid.

21. A baked good comprising a baked good fully enrobed in a primary lipid-based coating oil having a solid fat content of 68% to 87% at 20° C.;
said baked good with said primary lipid-based coating oil further fully enrobed in a secondary lipid-based coating selected from the group consisting of a compound coating and a chocolate coating.

22. The baked good as recited in claim 21 wherein the baked good comprises a bread, a cake, a sponge cake, a cookie, a muffin, or a cup cake.

23. The baked good as recited in claim 21 wherein said primary lipid-based coating oil has a Mettler Dropping Point of from 35 to 45° C.

24. The baked good as recited in claim 21 wherein said primary lipid-based coating oil has a solid fat content at 35° C. of 3% to 12%.

25. The baked good as recited in claim 21 wherein said primary lipid-based coating oil has a saturated fat content of greater than or equal to 95%.

26. The baked good as recited in claim 21 wherein said primary lipid-based coating oil has a trans fatty acid content of 2.5% or less.

27. The baked good as recited in claim 21 wherein said primary lipid-based coating oil comprises a coconut oil, a palm oil, a palm kennel oil, a hydrogenated coconut oil, a hydrogenated palm oil, a hydrogenated palm kernel oil, an interesterified coconut oil, an interesterified palm oil, an interesterified palm kernel oil, a soybean oil, a hydrogenated soybean oil, an interesterified soybean oil, a cottonseed oil, a hydrogenated cottonseed oil, an interesterified cottonseed oil, a canola oil, a hydrogenated canola oil, an interesterified canola oil, a sunflower oil, a hydrogenated sunflower oil, an interesterified sunflower oil, or blends thereof.

28. The baked good as recited in claim 21 wherein at least one of said primary lipid-based coating oil and said secondary lipid-based coating includes from 10 to 20 ppm of citric acid.

29. The baked good as recited in claim 21 wherein said primary lipid-based coating oil is present in an amount of from 2% to 8% by weight based on the total weight of said baked good.

30. The baked good as recited in claim 21 wherein said secondary lipid-based coating is present in an amount of from 35% to 45% by weight based on the total weight of said baked good and said primary lipid-based coating oil.

31. The baked good as recited in claim 21 wherein said secondary lipid-based coating is a compound coating and wherein the lipid component of said compound coating has a solid fat content at 20° C. of from 68% to 87%.

32. The baked good as recited in claim 21 wherein said secondary lipid-based coating is a compound coating and wherein the lipid component of said compound coating has a solid fat content at 35° C. of from 3% to 12%.

33. The baked good as recited in claim 21 wherein said secondary lipid-based coating is a compound coating and wherein the lipid component of said compound coating has a Mettler Dropping Point of from 35 to 45° C.

34. The baked good as recited in claim 21 wherein said secondary lipid-based coating is a compound coating and wherein the lipid component of said compound coating has a saturated fat content of greater than or equal to 95%.

35. The baked good as recited in claim 21 wherein said secondary lipid-based coating is a compound coating and wherein the lipid component of said compound coating comprises a coconut oil, a palm oil, a palm kernel oil, a hydrogenated coconut oil, a hydrogenated palm oil, a hydrogenated palm kernel oil, an interesterified coconut oil, an interesterified palm oil, an interesterified palm kernel oil, a soybean oil, a hydrogenated soybean oil, an interesterified soybean oil, a cottonseed oil, a hydrogenated cottonseed oil, an interesterified cottonseed oil, a canola oil, a hydrogenated canola oil, an interesterified canola oil, a sunflower oil, a hydrogenated sunflower oil, an interesterified sunflower oil, or blends thereof.
